(19) United States
(12) Patent Application Publication
(10) Pub. No.: US 2007/0043168 A1
(43) Pub. Date: Feb. 22, 2007

(54) Random copolymer to manufacture transparent extruded products

(75) Inventors: Leobardo Montiel-Ortiz, Tlaxcala (MX); Jose Martin Hernandez-Valdez, Tiaxcala (MX); Jaime Cortes-Rpmquillo, Tiaxcala (MX)

Correspondence Address: BROWDY AND NEIMARK, P.L.L.C.;624 NINTH STREET, NW, SUITE 300, WASHINGTON, DC, 20001-5303, US

(73) Assignee: Resirene, S.A. DE C.V., Sto. Toribio Xicohtzinco (MX)

(21) Appl. No.: 10/560,929

(22) PCT Filed: Sep. 16, 2003
(86) PCT No.: PCT/IB03/04087

§ 371 Date: Sep. 25, 2006

(51) Int. Cl. C08L 53/00

(52) U.S. Cl. 525/88; 526/319; 526/346

(57) ABSTRACT

The present invention relates to a random copolymer that is useful to manufacture transparent extruded products comprising: from 75 to 95% by weight of at least a vinyl aromatic monomer; from 0 to 15% by weight of at least an alkyl methacrylate monomer, wherein the alkyl moiety has from 1 to 4 carbon atoms; and from 0 to 25% by weight of at least an alkyl acrylate monomer, wherein the alkyl moiety has from 1 to 4 carbon atoms; the random copolymer may be mixed With a diblock or triblock copolymer containing styrene monomers in order to obtain pellets from the mixture that, when being processed by extrusion, does not exhibit the melt fracture phenomenon.

### FIELD OF THE INVENTION

The present invention relates to the techniques used in obtaining polymer compositions employed in the plastic industry and, more particularly, it relates to a random copolymer to manufacture transparent extruded products.

### BACKGROUND OF THE INVENTION

At present, for the sellers or manufacturers of several products such as food or toys, among others, it is essential to show and protect their products by using packages that are not only transparent but also rigid. In addition to allow consumers to observe the products they are going to buy, these physical features of transparency and rigidity concerning the packing materials provide an appropriate protection to such products, preventing them from being damaged.

The abovementioned packages are commonly known in the art as blisters, which are made of extruded polymer sheets and may be classified in four groups according to the polymers from which they are made, such groups being the following:

a) Packages made from biaxially oriented polystyrene (BOPS);

b) Packages made from PVC or PET;

c) Packages made from mixtures of crystal polystyrene (GPPS) with styrene-butadiene copolymers (SBC); and

d) Packages made from styrene-methyl methacrylate (SMMA) with styrene-butadiene copolymers (SBC).

Regarding the abovementioned groups, not all of them properly meet the required transparency and rigidity features since, for instance, packages made from biaxially oriented polystyrene (BOPS) show acceptable transparency features. However, they are too rigid, which makes them too fragile and easily broken.

Packages made from PVC or PET show acceptable transparency features and are outstanding for having a very high rigidity, which is a disadvantage rather than an advantage, since consumers should make great effort in trying to open a package made from these materials, being sometimes necessary to use sharp objects to open the package, which puts at risk both the consumer and the product contained inside such packages.

Regarding packages made from crystal polystyrene (GPPS) with styrene-butadiene copolymers (SBC), it may be said that they are not so rigid as those made from PVC or PET. However, they show transparency problems, since crystal polystyrene has a refractive index other than the one shown by styrene-butadiene copolymers and the SBC/GPPS mixture is thus optically incompatible.

Finally, packages made from styrene-methyl methacrylate polymers with styrene-butadiene copolymers (SBC) show acceptable transparency features and are not as rigid as PVC or PET packages. However, SMMA/SBC polymer composition shows problems when it is subjected to extrusion processes to form sheets or films which are then thermoformed to obtain packages. In particular, the phenomenon known as melt fracture arises, resulting in a reduction of transparency features in packages, since those sheets haze and may even show windings which distort the shape and color of the products contained in packages.

Regarding the abovementioned melt fracture phenomenon, it is worth mentioning that in many continuous processes for manufacturing plastic articles, the polymer is melted and passed through an extrusion die. The properties of the manufactured product, including the morphology developed when cooling and solidifying the polymer, greatly depend on the efforts and orientation resulting from extrusion. Most commercial polymers have molecular weights large enough in order for polymer chains to be enlarged in the melt, resulting in a flow behavior considerably different to that shown by liquids having low molecular weights.

Most linear polymers show instabilities during extrusion when they are subjected to enough efforts. The first manifestation of instability is the appearance of distortions in the extruded surface, which at times comes along with oscillatory flow. This phenomenon is known as melt fracture and results from rapid pulses in the fluid pressure and small ruptures in the extruded material surface, due to a broken adhesion between the polymer and the extrusion die wall. In other words, there is a sliding of the extruded polymer surface with respect to the molten polymer mass. The polymer surface cannot flow fast enough to remain with the extruded product mass, which results in a fracture of the molten product resulting in a loss of the superficial properties of the extruded product, such loss of properties being very noticeable when transparent sheets or films are intended to be manufactured.

In general, instabilities begin at the die wall near its entrance. Further, the material from which the die is made has been seen to have an impact on the appearance of instabilities.

In order to avoid melt fractures, a series of measures have been attempted, such as changing the process conditions, changing the equipment or the polymer being used. Some of the solutions that to present have resulted in the best results are adding an additive to reduce friction between the extrusion die and the fluid, or mixing a polymer with high molecular weight with another with lower molecular weight in order to reduce viscosity and thus constant efforts at the die. However, in commercial applications such as package manufacturing, changing formulation is not always feasible.

Likewise, in the state of the art, the U.S. Pat. No. 5,854,352 relates to the reduction of melt fractures in the extrusion of low-density linear polyethylene by using an additive for processing, such additive consisting of a mixture of a thermoplastic acrylic polymer and a fluoropolymer. More specifically, the additive for processing is an homogeneous mixture of a styrene-methyl methacrylate copolymer and a thermoplastic vinylidene fluoride and hexafluoropropylene copolymer. The styrene and methyl methacrylate copolymer composition is from 40 to 80% by weight of combined styrene and from 20 to 55% by weight of methyl methacrylate.

Returning to the SMMA/SBC type compositions, for being extruded that exhibit the problem of melt fractures. The U.S. Pat. No. 4,080,406 may be mentioned, which relates to a styrene composition comprising the product of a polymerization reaction of: a) 100 parts by weight of a monomer mixture comprising from 25 to 75% of a vinyl aromatic monomer; from 5 to 70% of ethyl or methyl methacrylate, and from 5 to 60% by weight of an alkyl methacrylate having at least four atoms in the alkyl group; and b) of about 2 to 30 parts by weight of a rubber selected from the group consisting of butadiene and a styrene and butadiene block copolymer.

Likewise, U.S. Pat. No. 4,680,337 depicts a composition comprising from 25 to 75 parts by weight of styrene monomers, from 7 to 30 parts by weight of butyl acrylate, from 10 to 50 parts in weight of methyl methacrylate, and from 2 to 20% of a styrene diblock or triblock copolymer.

It is worth mentioning that in U.S. Pat. Nos. 4,080,406 and 4,680,337, SMMA/SBC compositions result from a unique synthesis process. That is, all of the components, including styrene diblock or triblock compositions, are polymerized together. Due to this process, the final product is not proper to manufacture transparent extruded sheets, since the phenomenon of melt fracture arises. Therefore, the compositions of such documents may only be used in injection molding processes.

As it may be noticed from the above, the groups of materials currently known to manufacture packages which require to be transparent and rigid at the same time show considerable disadvantages, since none of them properly meets such features of transparency and rigidity. Although some of them show good transparency, they are fragile. Another is too rigid and pose problems since, upon trying to open it, it is necessary to use sharp objects. Likewise, another of the abovementioned groups does not have good transparency it is either rigid enough. The last group has the disadvantage of exhibiting the melt fracture phenomenon, which is an important visual problem.

On the other hand, in the state of the art, there is no SMMA/SBC type polymer composition not exhibiting the melt fracture phenomenon when being subjected to extrusion processes, a phenomenon that should be avoided in manufacturing blister type packages considerably requiring transparency features.

Consequently, the disadvantages exhibited by polymer compositions being currently used have been attempted to be overcome in order to manufacture transparent extruded products by developing a random copolymer which, when being mixed with SBC copolymers or other styrene copolymers, may be subjected to extrusion processes without the mixture exhibiting the melt fracture phenomenon and obtaining sheets of films that are useful to manufacture packages with excellent transparency and rigidity features.

### OBJECTS OF THE INVENTION

Considering the defects of the previous art, it is an object of the present invention to provide a random copolymer that, when being mixed with SBC type copolymers or other styrene copolymers, allows its application in extrusion processes without exhibiting the melt fracture phenomenon.

An additional object of the present invention is to provide a random copolymer allowing to obtain sheets and films having excellent transparency and rigidity features.

Yet another object of the present invention is to provide a random copolymer that may be used to manufacture blister type packages.

Yet another object of the present invention is to provide a random copolymer not requiring adding additives or other compositions to avoid the appearance of the melt fracture phenomenon.

### DETAILED DESCRIPTION OF THE INVENTION

It has been surprisingly found that a random copolymer of vinyl aromatic monomers, with both methacrylic and acrylic monomers, may be mixed with styrene block copolymers exhibiting proper properties in order to be used in extrusion processes allowing to manufacture films, thin sheets, and plates, wherein such extrusion products are ideal to obtain blister type packages having transparency and rigidity features appropriately meeting what is required for such packages.

In general, the random polymer of the present invention comprises: (a) at least one vinyl aromatic monomer in a strength ranging from 75 to 95% by weight, wherein the vinyl aromatic monomer is selected from the group consisting of monomers from styrene, α-methyl styrene, p-methyl styrene, ter-butyl styrene, 2-4 di-methyl styrene, and their bromated or chlorinated derivatives, styrene being preferably used; (b) at least an alkyl methacrylate monomer in a strength up to 15% by weight, wherein the alkyl moiety has from 1 to 4 carbon atoms, such alkyl methacrylate monomer being selected from the group consisting of methyl, ethyl, propyl, or butyl methacrylate monomers, methyl methacrylate being preferably used; and (c) at least an alkyl acrylate monomer up to 25% by weight, wherein the alkyl moiety has from 1 to 4 carbon atoms, such alkyl acrylate monomer being selected from the group consisting of methyl, ethyl, or butyl acrylate monomers, butyl acrylate being preferably used.

In an alternative embodiment of the present invention, the random copolymer comprises from 83 to 95% by weight of at least a vinyl aromatic monomer. Likewise, it is preferred that the random copolymer has a percentage weight of methacrylate monomers of up to 10%. Furthermore, in another alternative embodiment, the random copolymer comprises up to 7% by weight of at least an alkyl acrylate monomer.

Likewise, in a particularly specific embodiment of the present invention, the random copolymer comprises: (a) from 87 to 95% by weight of styrene; (b) from 5 to 10% by weight of methyl methacrylate; and (c) up to 3% by weight of butyl acrylate.

The properties exhibited by the random copolymer for the transparent extruded products of the present invention are:

Average molecular weight by number (Mₙ): from 70,000 to 140,000;

Average molecular weight by weight (M_{w}): from 140,000 to 270,000;

Polydispersity: from 2.0 to 2.8;

Melt flow index: from 2 to 20 g/10 min.

Along with its composition, these features make it appropriate to be used in combination with other copolymers without exhibiting the melt fracture phenomenon and it allows thus to obtain thin sheets and films which, by instance, may be 0.254 to 2.032 mm (0.010″ to 0.080″) in width, exhibiting excellent optical and superficial properties allowing them to be thermoformed to produce preferably blister type packages.

The random copolymer depicted in the present invention may be obtained by means of a process including the stages of: a) a continuous agitating reactor is added with a solution of vinyl aromatic monomers, both methacrylic and acrylic, such reactor operating at a temperature of about 120° C. (248° F.) and a residence time of about 2 hours; b) then, the resulting mixture is taken to a tubular reactor at an outlet temperature of about 160° C. (320° F.) and a residence time of 1 hour, resulting in the random copolymer of the present invention, while unconverted monomers are withdrawn by devolatilization in a vacuum chamber; and (c) the random copolymer resulting from the tubular reactor is turned into pellets which are then processed to obtain various articles. Regarding this, it will be apparent for the one skilled in the art that the random copolymer of the present invention may also result from other processes, such as a suspension, mass-suspension polymerization, etcetera.

On the other hand, it has been surprisingly found that a mixture of the random copolymer of the present invention with diblock or triblock copolymers containing styrene monomers is particularly appropriate to manufacture extruded products having good transparency and rigidity features, the polymer mixture comprising: (a) from 1 to 75% by weight of the random copolymer of the present invention; and (b) from 25 to 99% by weight of at least a diblock or triblock copolymer containing styrene or mixtures thereof.

The diblock or triblock copolymer containing styrene is selected from the group consisting of styrene-butadiene, styrene-butadiene-styrene, styrene-isoprene, styrene-isoprene-styrene copolymers and the partially hydrogenated derivatives thereof, a diblock styrene-butadiene copolymer with a strength from about 15 to 35% by weight of butadiene being preferably used.

In order for the abovementioned polymer mixture to be used in extrusion processes, diblock or triblock copolymers containing styrene, as well as the mixtures thereof, should have a minimal average molecular weight by number (Mn) of 70,000 and a minimal average molecular weight by weight (Mw) of 120,000.

This polymer mixture is particularly appropriate to manufacture thin sheets and films by means of extrusion processes. For instance, sheets being 0.254 to 2.032 mm (0.010″ to 0.080″) width may be obtained, which will have excellent optical and superficial properties that may be thermoformed to produce mainly blister type packages.

It is worth mentioning that the polymer mixtures is obtained by mixing pellets of the random copolymer depicted in any of the embodiments of the present invention with pellets of diblock or triblock copolymers containing styrene, wherein the mixture of pellets from both components is coextruded in turn to obtain thus pellets from the polymer mixture.

The random copolymer of the present invention and the mixtures that may be obtained including it will be more clearly illustrated with the examples provided below, which are submitted merely with illustrative and non limitative purposes.

### EXAMPLES 1-7

Preparation of the Random Copolymer

7 different solutions of acrylic and methacrylic vinyl aromatic monomers were prepared according to the formulations that are detailed in Table 1. Each solution was fed into a continuous agitating reactor operating at a temperature of 120° C. (248° F.) and a residence time of about 2 hours. The copolymer and unreacted monomers mixture was then taken into a tubular reactor operating at an outlet temperature of 160° C. (320° F.) and a residence time of 1 hour, resulting finally in the random copolymer. Any unconverted monomers were withdrawn by devolatilization in a vacuum chamber. The resulting product was then pelletized. Also, the distribution of molecular weights was characterized (Table 2).

TABLE 1

| | | Methyl | Alkyl Acrylate | |
|---|---|---|---|---|
| | Styrene | Methacrylate | Monomer | |
| Copolymer | (% by weight) | (% by weight) | (% by weight) | Starter |
| CP01 | 90 | 10 | 0 | 0.012 |
| CP02 | 80 | 20 | 0 | 0.012 |
| CP03 | 85 | 0 | 15⁽²⁾ | 0.018 |
| CP04 | 90 | 0 | 10⁽³⁾ | 0.018 |
| CP05 | 90 | 8 | 2⁽³⁾ | 0.015 |
| CP06 | 88 | 10 | 2⁽¹⁾ | 0.012 |
| CP07 | 90 | 8 | 2⁽²⁾ | 0.015 |

Superindexes ⁽¹⁾, ⁽²⁾, and ⁽³⁾ indicate methyl, ethyl, and butyl methacrylate, respectively.

TABLE 2

| | Average Molecular Weight | Average Molecular Weight |
|---|---|---|
| Copolymer | by Number, Mn | by Weight, Mw |
| CP01 | 108,527 | 237,887 |
| CP02 | 129,964 | 238,331 |
| CP03 | 118,778 | 236,638 |
| CP04 | 89,567 | 180,233 |
| CP05 | 126,073 | 243,637 |
| CP06 | 135,434 | 242,931 |
| CP07 | 127,929 | 241,406 |

Preparation of Polymer Mixtures

Every random polymer previously depicted was mixed with a block copolymer having an approximate composition of 75% styrene and 25% butadiene, produced by Chevron Phillips, at a ratio of 60/40% by weight and were coextruded in a double spindle extruder using the temperature profile shown in Table 3 to obtain pellets of the polymer mixture.

TABLE 3

| | Initial Temperature |
|---|---|
| Melt Temperature | 216° C. (421° F.) |

Temperature of Barrel Heating Areas

| | |
|---|---|
| Throat | 188° C. (371° F.) |
| Center | 204° C. (400° F.) |
| Nozzle | 216° C. (421° F.) |

Sheet Manufacturing

Using the pellets resulting from the polymer mixture, sheets of 0.762 mm (0.030″) were prepared in a Killions David Standard (Model 21384) sheet extruder machine. During the manufacturing of sheets, no melt fracture phenomenon was observed at any moment, except for sheets manufactured using the copolymer CP02 having a contents of 20% by weight of methyl methacrylate, a value which exceeds the upper limit that this component should have in the random copolymer of the present invention. Table 4 summarizes the properties measured on these sheets.

TABLE 4

| | Final | Breaking | | Final | Breaking | | |
|---|---|---|---|---|---|---|---|
| | Strength | Strength | Elongation | Strength | Strength | Elongation | |
| | DM | DM | at break | DT | DT | at break | |
| | PSI | PSI | (DM) | PSI | PSI | (DT) | Transmittance |
| | (kg/cm²) | (kg/cm²) | % | (kg/cm²) | (kg/cm²) | % | % |
| CP01 | 4,885 | 3,690 | 47 | 3,855 | 3,300 | 120 | 85.55 |
| | (343.45) | (259.43) | | (271.03) | (232.01) | | |
| CP02 | 4,570 | 3,340 | 60 | 3,730 | 3,520 | 116 | 82.35 |
| | (321.30) | (234.83) | | (262.24) | (247.48) | | |
| CP03 | 4,360 | 3,160 | 67 | 3,570 | 3,300 | 160 | 84.63 |
| | (306.54) | (222.17) | | (251.00) | (232.01) | | |
| CP04 | 5,321 | 3,540 | 32 | 3,600 | 2,960 | 124 | 84.50 |
| | (374.10) | (248.89) | | (253.11) | (208.11) | | |
| CP05 | 5,260 | 3,480 | 41 | 4,100 | 3,350 | 84 | 85.52 |
| | (369.81) | (244.67) | | (288.26) | (235.53) | | |
| CP06 | 4,630 | 3,000 | 44 | 3,640 | 3,230 | 134 | 84.97 |
| | (325.52) | (210.92) | | (255.92) | (227.09) | | |
| CP07 | 4,960 | 4,570 | 27 | 3,740 | 3,555 | 80 | 84.81 |
| | (348.72) | (321.30) | | (262.95) | (249.94) | | |

Wherein:
DM = Longitudinal direction
DT = Transversal direction

Also, several products were manufactured from these sheets, such as blister type packages and packages for fresh products, disposable plastic glasses, among others, which had quite acceptable transparency and rigidity.

### EXAMPLE 8

A random copolymer was prepared with 85% styrene, 12% methyl methacrylate, and 5% butyl acrylate. The average molecular weight Mn of the resulting copolymer was 80,000, with a melt flow of 6 gr/10 min.

This copolymer was mixed as depicted in Examples 1-7 with every of the following styrene and butadiene block copolymers (SBC):

a) a SBC from Kraton Polymers with a molecular weight Mn of 92,000 and a contents of polybutadiene as measured by RMN of 25.7%.

b) a SBC from BASF with a molecular weight Mn of 106,000 and 27.3% of polybutadiene as measured via RMN.

Using the pellets resulting from these mixtures, sheets having 0.762 mm (0.030″) of thick were manufactured with no melt fracture phenomenon at any moment. Sheets were subjected to thermoforming processes in a Tommy Nielsen blister machine Model 501 F with 8 cavities, resulting in a thermoformed product for blister type packages having 88% of transmittance at 560 nm, as measured in Datacolor equipment. Thermoforming and sealing conditions were the following (these are the operating conditions for a commonly used material to manufacture blister type packages, specifically PVC).

| Variable | Unit | PVC | Example 8 |
|---|---|---|---|
| Contact time | Sec | 2 | 2 |
| Forming time | Sec | 2 | 2 |
| Sealing time | Sec | 3 | 4 |
| Oven temperature | ° C. (° F.) | 118 (245° F.) | 110 (230° F.) |
| Sealing pressure | Kg/cm² | 7.5 | 7.5 |

Blister type packages resulting from these copolymer show better transparency than PVC, although the latter are more rigid.

Also, these sheets were used to manufacture several products, such as blister type packages and packages for fresh products, disposable plastic glasses, among others, which exhibited satisfactory transparency and rigidity properties.

According to what has been depicted above, it may be seen that the random copolymer of the present invention has been created for extrusion processes to manufacture films, thin sheets, and plates, with the advantage that, upon subjecting them to such extrusion processes, there is no melt fracture phenomenon. It will be apparent for the one skilled in the art that the embodiments depicted before are only illustrative and non limitative of the present invention, since several changes in details are possible without departing from the scope of the invention, as it may be the selection of vinyl aromatic monomers, both methacrylic and alkyl acrylic, among others. Also, it will be apparent that the same copolymer may be subjected to injection processes to manufacture other transparent articles.

Although a specific embodiment of the present invention has been depicted and exemplified, it should be mentioned that several modifications are possible. Therefore, the present invention should not be considered to be limited except for what is required by the previous art and the scope of the appended claims.

1. A random copolymer comprising: a) at least a vinyl aromatic monomer at a strength ranging from 75 to 95% by weight; b) at least an alkyl methacrylate monomer at a strength of up to 15% by weight, wherein the alkyl moiety has from 1 to 4 carbon atoms; and c) at least an alkyl acrylate monomer at a strength of up to 25% by weight, wherein the alkyl moiety has from 1 to 4 carbon atoms.

2. The random copolymer according to claim 1 further comprising from 83 to 95% by weight of at least one vinyl aromatic monomer.

3. The random copolymer according to claim 1 further comprising up to 10% by weight of at least an alkyl acrylate monomer.

4. The random copolymer according to claim 1 further comprising up to 7% by weight of at least an alkyl acrylate monomer.

5. The random copolymer according to claim 1 wherein the vinyl aromatic monomer is further selected from the group consisting of styrene, α-methyl styrene, p-methyl styrene, ter-butyl styrene, 2,4 di-methyl styrene monomers and the bromated or chlorinated derivatives thereof.

6. The random copolymer according to claim 5 wherein the vinyl aromatic monomer is styrene.

7. The random copolymer according to claim 1 wherein the alkyl methacrylate monomer is further selected from the group consisting of methyl, ethyl, or butyl methacrylate monomers.

8. The random copolymer according to claim 7 wherein the alkyl methacrylate monomer is methyl methacrylate.

9. The random copolymer according to claim 1 wherein the alkyl acrylate monomer is further selected from the group consisting of methyl, ethyl, or butyl acrylate monomers.

10. The random copolymer according to claim 9 wherein the alkyl acrylate monomer is butyl acrylate.

11. The random copolymer according to claims 6, 8, and 10 further comprising: (a) from 87% to 95% by weight of styrene; (b) from 5% to 10% by weight of methyl methacrylate; and (c) up to 3% by weight of butyl acrylate.

12. The random copolymer according to claim 1 further having an average molecular weight by number (Mₙ) from 70,000 to 140,000; an average molecular weight (M_{w}) from, 140,000 to 270,000; a polydispersity from 2.0 to 2.8; and a melt flow index from 2 to 20 g/10 min.

13. A polymer mixture comprising: (a) from 1 to 75% by weight of the random copolymer as claimed in claim 1; and (b) from 25 to 99% by weight of at least a diblock or triblock copolymer containing styrene monomers or mixtures thereof.

14. The polymer mixture according to claim 13 wherein the diblock copolymer is further selected from the group consisting of styrene-butadiene, styrene-isoprene copolymers and the partially hydrogenated derivatives thereof.

15. The polymer mixture according to claim 14 wherein the diblock copolymer is styrene-butadiene containing from 15 to 35% by weight of butadiene.

16. The polymer mixture according to claim 13 wherein the triblock copolymer is further selected from the group consisting of styrene-butadiene-styrene, styrene-isoprene-styrene copolymers and the partially hydrogenated derivatives thereof.

17. The polymer mixture according to claim 13 wherein the diblock or triblock copolymer and the mixtures thereof should have a minimal average molecular weight by number (Mn) of 70,000 and a minimal average molecular weight by weight (Mw) of 120,000 in order for such a polymer mixture to be used in extrusion processes.

18. The polymer mixture according to claim 13 wherein the mixture can be further used in extrusion processes to manufacture films, thin sheets, or plates, which may be subjected to a thermoforming process to manufacture several products having excellent superficial and optical properties, such as blister packages.
